(19) United States
(12) Patent Application Publication
(10) Pub. No.: US 2007/0051803 A1
(43) Pub. Date: Mar. 8, 2007

(54) Delivery product management system

(75) Inventors: Nobuyuki Tada, Odawara (JP); Nobuaki Higashi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/516,592

(22) Filed: Sep. 7, 2006

(30) Foreign Application Priority Data
Sep. 7, 2005 (JP) 2005-258775

(51) Int. Cl. G07B 15/02

(52) U.S. Cl. 235/384; 235/385

(57) ABSTRACT

A delivery product management system for managing a delivery product with an RFID tag includes: a delivering site terminal provided with a delivering site reader-writer for reading and writing, or for reading information stored in the RFID tag; and a receiving site terminal provided with a receiving site reader for reading information stored in the RFID tag, wherein, the delivering site terminal reads identification information from the RFID tag of the delivery product by using the delivering site reader-writer, and writes delivery information containing at least delivery address information of the delivery product in the RFID tag after checking that the delivery product is correct based on the identification information, and the receiving site terminal reads the delivery address information from the RFID tag of the delivery product by using the receiving site reader, and checks whether or not a receiving site is correct for receiving the delivery product.

### CROSS REFERENCE TO RELATED APPLICATIONS

This application claims the foreign priority benefit under Title 35, United States Code, §119(a)-(d) of Japanese Patent Application No. 2005-258775, filed on Sep. 7, 2005, the contents of which are hereby incorporated by reference.

### BACKGROUND OF THE INVENTION

1. Field of the Invention

The present invention relates to a delivery product management system, and, more particularly to a delivery product management system for preventing an erroneous delivery of the delivery product and for checking an arrival delay of the delivery product.

2. Description of Relevant Art

As an external storage medium for data backup of, for example, a computer, a magnetic tape cartridge has been known. Generally, a plurality of magnetic tape cartridges in which data is stored are kept in a rack CS as shown in FIG. 7, the rack CS being installed in a fire and heat resistant cabinet. Also, when the magnetic tape cartridge MC is taken out from the cabinet, the cartridge MC is transported by loading it on a carrying wagon C as shown in FIG. 8.

In the meantime, for example, important confidential data is stored in a magnetic tape cartridge in some case. Therefore, a careful Management of the magnetic tape cartridge is required. Especially, when the magnetic tape cartridge is taken out to an exterior, management for a projected delivery is required for preventing the magnetic tap cartridge from an erroneous delivery and a bootstrapping during the transportation.

A library system for managing a transportation status relating to storing and delivering of such a magnetic tape cartridge to and from a warehouse has been proposed in claim 1, paragraphs [0007], [0008], and FIG. 1 of Japanese Laid-Open Patent Publication No. 2003-63625. Specifically, the library system includes a storage unit where a plurality of magnetic tape cartridges on which a barcode is pasted are stored, a transportation unit which has a reader for reading the barcode of the magnetic tape cartridges and transports the magnetic tape cartridges relating to the storing and delivering of the magnetic tape cartridges, a borrower terminal installed at a borrower side, and a management unit for managing location information of the magnetic tape cartridges relating to the storing and delivering.

The management unit has storage location information of a magnetic tape cartridge, and generates a delivery instruction containing the storage location information of, for example, a magnetic tape cartridge which is requested to deliver from the borrower terminal, and transmits the delivery instruction to the transportation unit. The transportation unit reads a barcode of the magnetic tape cartridge which is deposited on the transportation unit based on a content of the delivery instruction, and transmits identification information based on the barcode to the management system. Through the above, the management unit can obtain location information of each magnetic tape cartridge whether the cartridge is stored in the storage unit or in transportation by the transportation unit.

Therefore, for example, if the identification information stored in the management unit is checked by the borrower terminal when the magnetic tape cartridge is arrived at the borrower, the magnetic tape cartridge can be prevented from an erroneous delivery, and checking of the arrival delay of the magnetic tape cartridge can be implemented.

In addition, another system is disclosed in claim 1, paragraphs [0037] to [0041], and FIG. 1 of Japanese Patent No. 365715, where an electronic tag (RFID tag: Radio Frequency IDentification tag) is mounted on a product to be delivered, summary data such as a passing time, a temperature, and a humidity at each passing site, as well as information of each passing site and a delivery address are additionally registered in the tag and checked by an electronic tag reader unit connected to a collection and delivery management center installed at each site, then if the product is on a way out of a distribution channel, an alarm is issued.

However, according to the system described in the Japanese Laid-Open Patent Publication No. 2003-63625, when the borrower terminal refers to the management unit, the management unit and the borrower terminal are necessary to be online connection. Therefore, a service of the system has been stopped when a host computer or network is, for example, in trouble or maintenance.

The problem described above is not limited to a magnetic tape cartridge, and all delivery products managed by the system have the same problem.

Further, in the system described in the Japanese Patent No. 365715, since products are managed by a centralized control at a collection and delivery management center, a similar problem to that of the Japanese Laid-Open Patent Publication No. 2003-63625 takes place in, for example, a trouble and maintenance of the network. In addition, since the system has various kinds of functions, such as a real time tracking of a product in delivery, storing of environment data in delivery, and an alarm function for an erroneous delivery, a running cost of the system is expensive.

It is, therefore, an object of the present invention to provide a delivery product management system which is able to prevent an erroneous delivery and check an arrival delay of a delivery product, as well as eliminating the aforementioned problems.

### SUMMARY OF THE INVENTION

According to a first aspect of the present invention, there is provided a delivery product management system for managing a delivery product by an RFID tag, the delivery product management system includes a delivering site terminal provided with a delivering site reader-writer for reading and writing, or for reading information stored in the RFID tag; a receiving site terminal provided with a receiving site reader for reading information stored in the RFID tag, wherein the delivering site terminal reads identification information from the RFID tag of the delivery product by using the delivering site reader-writer, and writes delivery information containing at least delivery address information of the delivery product in the RFID tag after checking that the delivery product is correct based on the identification information, and the receiving site terminal reads the delivery address information from the RFID tag of the delivery product by using the receiving site reader, and checks whether or not a receiving site is correct for receiving the delivery product.

In the first aspect of the present invention, when the delivery product is arrived at the receiving site, the receiving site terminal reads the delivery address information of the delivery product. Then, the receiving site terminal checks whether or not the site is correct for receiving the delivery product. That is, since the delivery information such as the delivery address information has been managed by a management apparatus in the related art, the management apparatus and the receiving site terminal are required to be Online for checking whether or not the receiving site is correct. However, in the present invention, since the delivery information is directly written in the RFID tag mounted on the delivery product, the receiving site terminal can check an erroneous delivery by itself without referring information to the management apparatus.

According to a second aspect of the present invention, there is provided a delivery product management system in which the delivering site terminal writes the delivery information containing at least the delivery address information and information of a projected arrival time at the receiving site in the RFID tag of the delivery product by using the delivering site reader-writer, and the receiving site terminal reads the information of the projected arrival time from the RFID tag of the delivery product by using the receiving site reader, and checks whether or not a delay of an arrival time of the delivery product exists by comparing an actual arrival time of the delivery product and the projected arrival time.

In the second aspect of the above invention, when the delivery product is arrived at the receiving site, the receiving site terminal reads information of the projected arrival time of the delivery product. Then, the receiving site terminal checks the projected arrival time and the actual arrival time of the delivery product. That is, similar to the first aspect, the receiving site terminal can check the arrival delay by itself without referring information to the conventional management apparatus.

Meanwhile, when the actual arrival time is substantially delayed compared with the projected arrival time, a possibility of an information leakage by bootstrapping during the transportation can be suspected.

In the first aspect of the present invention, a receiving site for a delivery product can be checked by a receiving site terminal by itself without connecting all site terminals to Online, thereby resulting in prevention of an erroneous delivery of the delivery product.

In the second aspect of the present invention, a receiving site terminal can check a projected arrival time of a delivery product by itself without connecting all site terminals to Online, thereby the receiving site terminal can check whether or not an arrival of the delivery product is delayed compared with the projected arrival time. Through this, a possibility of an information leakage by bootstrapping during the transportation can be checked.

### BRIEF DESCRIPTION OF THE DRAWINGS

FIG. 1 is an illustration showing a configuration of a delivery product management system according to an embodiment of the present invention;

FIG. 2 is an illustration showing a configuration of a terminal and a tag of the embodiment;

FIG. 3 is an example showing a delivery product list of the embodiment;

FIG. 4 is an example showing an erroneous delivery product list of the embodiment;

FIG. 5 is a flowchart showing an operation flow of a terminal installed in a storage cabinet;

FIG. 6 is a flowchart showing an operation flow of a terminal installed in a computer room;

FIG. 7 is a perspective view of a rack for storing a magnetic tape cartridge; and

FIG. 8 is a perspective view of a carrying wagon for carrying a magnetic tape cartridge.

### DETAILED DESCRIPTION OF THE PREFERRED EMBODIMENT

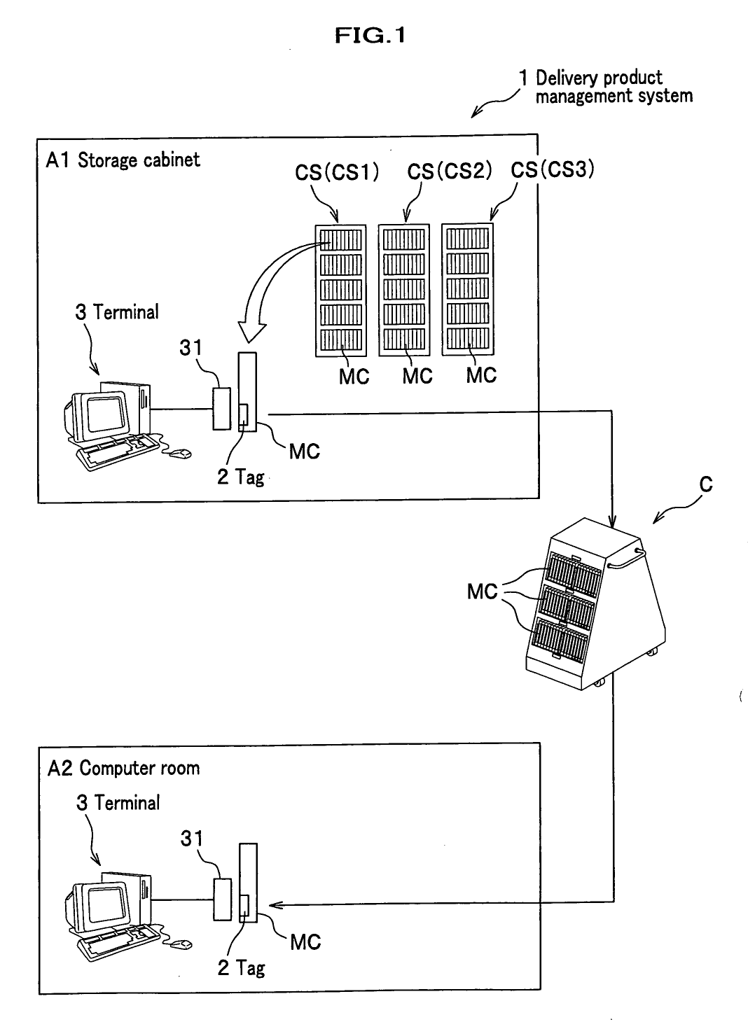

Next, an embodiment of the present invention will be explained in detail by referring to figures, as needed. FIG. 1 is an illustration showing a configuration of a delivery product management system according to an embodiment of the present invention. In the embodiment, a magnetic tape cartridge is supposed as a delivery product. However, the delivery product is not limited to the magnetic tape cartridge, and various kinds of delivery products may be a target of the management.

As shown in FIG. 1, a magnetic tape cartridge MC is kept in general in a rack CS (CS1 to CS3) in a storage cabinet A1 (delivering site) and delivered to an external quarter by loading the magnetic tape cartridge MC on a carrying wagon C based on a delivery request from the external quarter, such as a computer room A2 (receiving site).

The delivery product management system 1 according to the embodiment manages, such as a delivery address of a magnetic tape cartridge MC on which a tag 2 (RFID tag: Radio Frequency IDentification) is mounted, when the magnetic tape cartridge is transported from the storage cabinet to the computer room A2. The storage cabinet A1 and the computer room A2 are provided with a terminal 3, respectively. The terminal 3 serves as a delivering site terminal and a receiving site terminal.

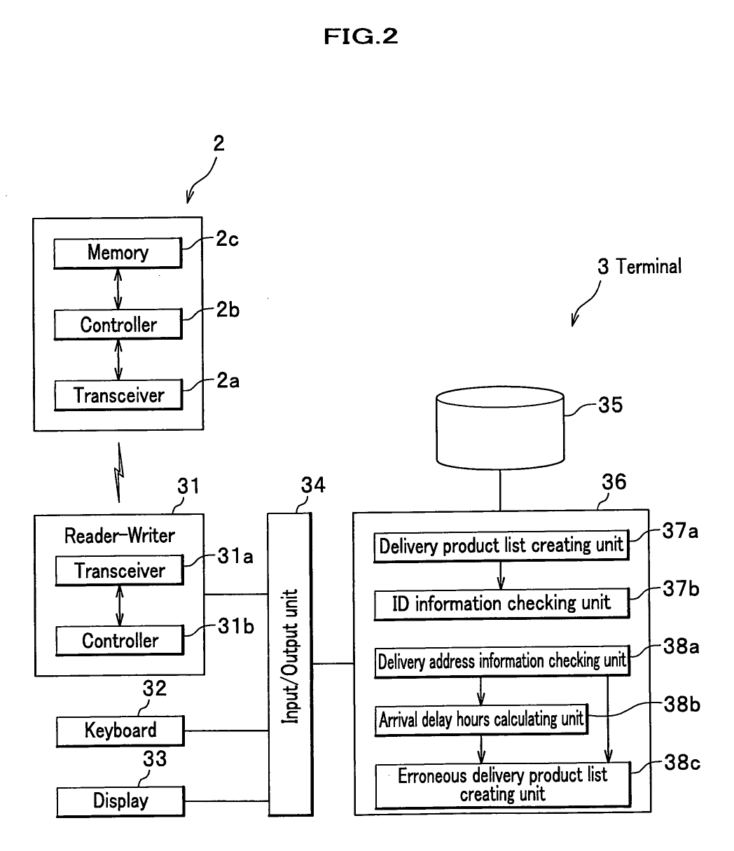

FIG. 2 is an illustration showing a configuration of a terminal and a tag. First, the tag 2 mounted on a magnetic tape cartridge MC will be explained. As shown in FIG. 2, the tag 2 includes a transceiver 2a, a controller 2b, and a memory 2c. The transceiver 2a is a coiled antenna, and connected to the controller 2b and the memory 2c. In the memory 2c of the tag 2, various kinds of information such as ID (IDentification) information of the magnetic tape cartridge and location information of the cartridge in the storage cabinet A1 are stored. Meanwhile, the ID information and the location information in registered information in the memory 2c are almost never renewed. ID information of a magnetic tape cartridge MC is also displayed on a label of a cartridge case of the magnetic tape cartridge MC, and can be read with eyes.

In addition, the tag T2 is configured to be capable of communication with a reader-writer 31, which will be described later. It is preferable to use a tag T2 which has a long communication distance with the reader-writer 31. With this communication ability, a time required for a checking operation of a magnetic tape cartridge can be shortened.

Further, the tag 2 may be mounted (for example, with pasting) externally (hereinafter, referred to as external tag), or may be mounted internally (hereinafter, referred to as internal tag) on a magnetic tape cartridge MC. Since the tag T2 is supposed to be mounted on a product traveling back and forth between specific sites, the tag T2 is continuously used without being removed if it is once mounted.

The terminal 3 manages a storing and delivering status of a magnetic tape cartridge MC as a delivering site terminal (a terminal installed in the storage cabinet A1), and also manages whether or not an address where the magnetic tape cartridge MC is delivered is correct as a receiving site terminal (a terminal installed in the computer room A2). The terminal 3 includes a reader-writer 31, a keyboard 32, a display 33, an input/output unit 34, a storage 35, and a controller 36.

The reader-writer 31 includes a transceiver 31a and a controller 31b. The reader-writer 31 communicates with a transceiver 2a of the tag 2 via the transceiver 31a, and is capable of reading or writing information stored in the memory 2c of the tag T2 without contact.

In addition, the keyboard 32 is an operating member for inputting various kinds of information in the controller 36 via the input/output unit 34 together with the reader-writer 31, and operated when an operator creates a delivery product list, which will be described later. The display 33 displays information output from the controller 36 via the input/output unit 34, and displays the delivery product list and an erroneous delivery product list. The storage 35 includes a RAM (Random Access Memory) which is used for, for example, processing of the controller 36 described later, a ROM (Read Only Memory) for storing various kinds of information, and an external storage unit such as a hard disk. Further, a storing location (for example, numbers of shelf and rack) information map of a magnetic tape cartridge MC in the storage cabinet A1 is stored in the terminal 3 installed in the storage cabinet A1.

The controller 36 includes, for example, a CPU (Central Processing Unit), a delivery product list creating unit 37a, an ID information checking unit 37b, a delivery address information checking unit 38a, a delay hours calculating unit 38b, and an erroneous delivery product list creating unit 38c. Among them, the delivery product list creating unit 37a and the ID information checking unit 37b are functional members of the terminal 3 installed in the storage cabinet A1 as a delivering site terminal, and the delivery address information checking unit 38a, the delay hours calculating unit 38b, and the erroneous delivery product list creating unit 38c are functional members of the terminal 3 installed in the computer room A2 as a receiving site terminal.

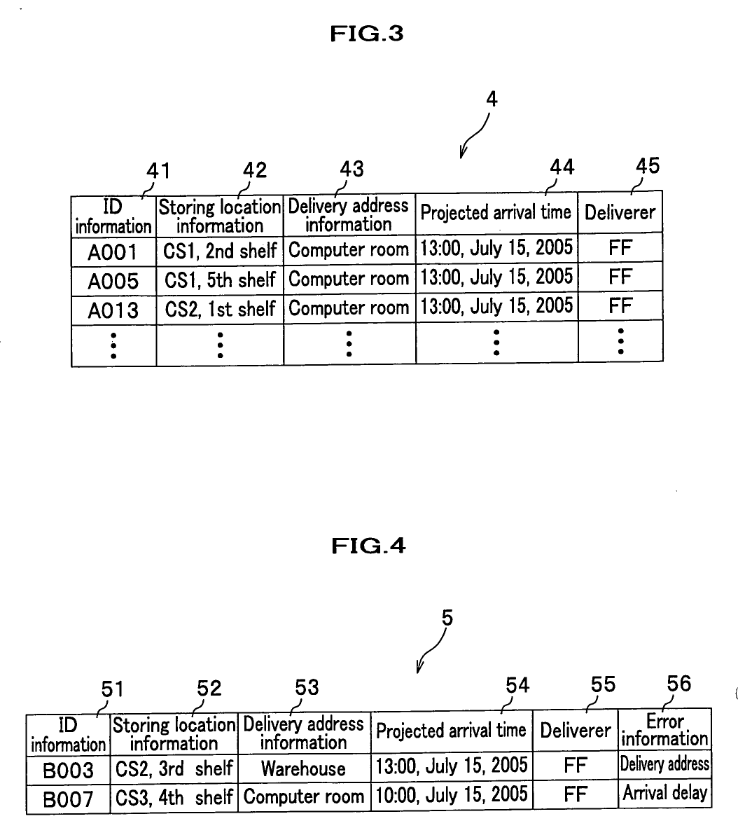

First, the functional members of the terminal 3 installed in the storage cabinet A1 will be explained. The delivery product list creating unit 37a creates a delivery product list of a magnetic tape cartridge to be taken out from magnetic tape cartridges being kept in the storage cabinet A1. An example of the delivery product list is shown in FIG. 3. As shown in FIG. 3, the delivery product list 4 includes ID information 41 specific to a magnetic tape cartridge MC, storing location information 42 indicating a storing location (for example, numbers of shelf and rack) of the cartridge MC in the storage cabinet A1, delivery address information 43 indicating a receiving site (for example, computer room A2), a projected arrival time 44 at the receiving site, and a deliverer 45 delivering the magnetic tape cartridge MC from the storage cabinet A1 to the receiving site.

Specifically, if an operator inputs ID information 41, delivery address information 43, a projected arrival time 44, and a name of the deliverer of a magnetic tape cartridge MC which is requested to deliver, through the keyboard 32, the delivery product list creating unit 37a creates a delivery product list 4 shown in FIG. 3. Here, storing location information 42 is automatically input because the delivery product list creating unit 37a reads out the storing location information map in the storage 35 when the ID information 41 is input. In addition, the projected arrival time 44 may be one input by the operator by estimating an arrival time for each case, and also may be one automatically input by estimating the arrival time from a current time and a time necessary for transporting the magnetic tape cartridge MC to a predetermined delivery address, by inputting delivery address information 43. The created delivery product list 4 is displayed on the display 33 via the input/output unit 34.

Meanwhile, the delivery address information 43, the projected arrival time 44, and the deliverer 45 are examples of delivery information.

As shown in FIG. 2, the reader-writer 31 reads out ID information of the tag 2 of a magnetic tape cartridge MC taken out from a rack CS, then the ID information checking unit 37b checks whether or not the ID information corresponds to the ID information 4 which is listed in the delivery product list 4. If the ID information corresponds, the ID information checking unit 37b writes delivery address information 43, a projected arrival time 44, and a deliverer 45, which are other items of the delivery product list 4, in the tag 2.

Next, functional members of the terminal 3 installed in the computer room A2 will be explained. The delivery address information checking unit 38a checks whether or not installing site information of the terminal 3 thereof is preset, and also checks whether or not the computer room A2 is a correct delivery address of a delivered magnetic tape cartridge MC. Specifically, the reader-writer 31 reads delivery address information stored in the tag 2, and confirms that the delivery address is the computer room A2. If the address is correct, a confirmed result is transmitted to the delay hours calculating unit 38b, and if the address is incorrect, the confirmed result is transmitted to the erroneous delivery product list creating unit 38c.

The delay hours calculating unit 38b calculates an arrival delay hours of a magnetic tape cartridge MC of which delivery address is the computer room A2 in the delivery address information checking unit 38a. Specifically, the reader-writer 31 reads out a projected arrival time stored in the tag 2 of each magnetic tape cartridge MC, and if a current time has already passed the projected arrival time, the delay hours calculating unit 38b calculates a difference (hereinafter, referred to as delay time) between the projected arrival time and the current time. If the delay time exceeds predetermined hours (for example, one hour), the delay time is transmitted to the erroneous delivery product list creating unit 38c as an arrival delay.

The erroneous delivery product list creating unit 38c creates an erroneous delivery product list for a magnetic tape cartridge MC of which delivery address is incorrect and for a magnetic tape cartridge MC of the arrival delay (hereinafter, the magnetic tape cartridge MC corresponding to these cartridges is referred to as erroneous delivery product), among magnetic tape cartridges MC delivered to the computer room A2. An example of the erroneous delivery product list is shown in FIG. 4. As shown in FIG. 4, the erroneous delivery product list 5 has identical items to those of the delivery product list 4 shown in FIG. 3, and includes ID information 51, storing location information 52, delivery address information 53, a projected arrival time 54, a deliverer 55, and error information 56. Here, the error information 56 indicates a type of a delivery error, that is, the error indicates a delivery address error or an arrival delay error.

Specifically, a magnetic tape cartridge MC of the erroneous delivery product is extracted based on processing results which are transmitted from the delivery address information checking unit 38a and the delay hours calculating unit 38b, then the erroneous delivery product list 5 is created. The created erroneous delivery product list 5 is displayed on the display 33 via the input/output unit 34.

Next, a delivering site operation procedure in the storage cabinet A1 and a receiving site operation procedure in the computer room A2, as well as an operation of the terminal 3 will be explained.

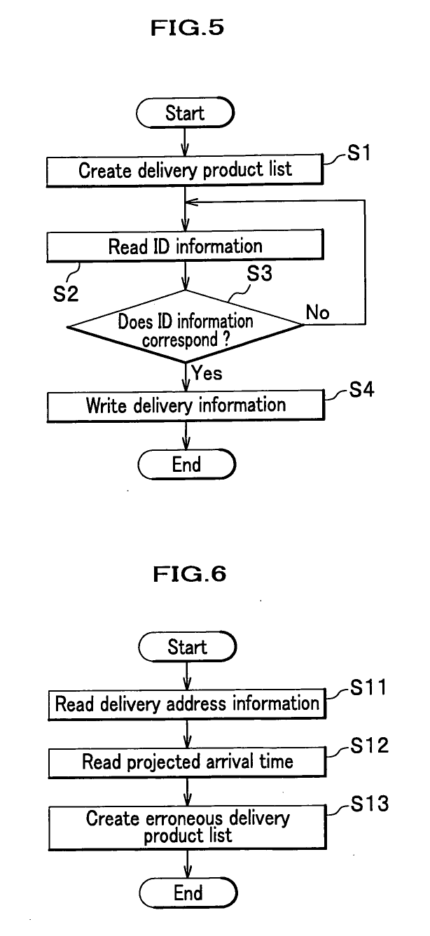

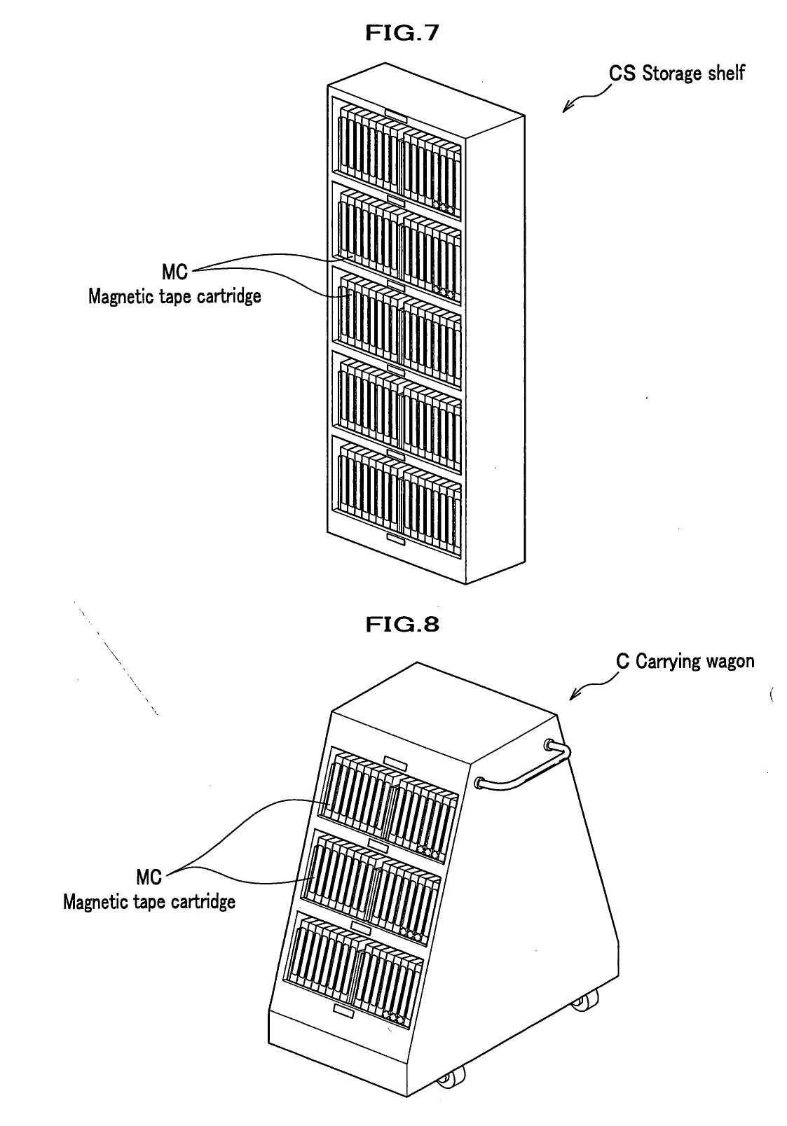

First, the delivering site operation procedure in the storage cabinet A1 will be explained, by referring to FIG. 5, together with FIG. 2 as needed. FIG. 5 is a flowchart showing an operation flow of a terminal installed in a storage cabinet.

At the beginning, if a delivery request is placed for a magnetic tape cartridge MC kept in the storage cabinet A1 from a plurality of external quarters, for example, such as the computer room A2, an operator inputs ID information 41, delivery address information 43, a projected arrival time 44, and a deliverer 45 of the magnetic tape cartridge MC through the key board 32 based on the delivery request, and a delivery product list 4 (refer to FIG. 3) is created by the delivery product list creating unit 37a (Step S1). The created delivery product list 4 is displayed on the display 33. Then, the operator collects each magnetic tape cartridge MC from each rack CS according to the delivery product list 4, by loading the cartridge MC on a carrying wagon C (refer to FIG. 1).

Then, the terminal 3 reads ID information (Step S2) stored in the tag 2 of each magnetic tape cartridge MC which is collected on the carrying wagon C, and checks whether or not the ID information corresponds to the ID information 41 (refer to FIG. 3) of the magnetic tape cartridge MC listed in the delivery product list 4 (Step S3). If the ID corresponds (Step S3: Yes), subsequently, the reader-writer 31 writes delivery address information, a projected arrival time, and information of a deliverer in the tag 2 of the magnetic tape cartridge MC. On the other hand, if the ID information does not correspond (Step S3: No), the magnetic tape cartridge is unloaded from the carrying wagon C, and the procedure returns to the step S2 and same operations after the step S2 are repeated for a magnetic tape cartridge MC other than the unloaded one. If writing of the delivery information for all magnetic tape cartridges MC, which are to be delivered, is completed, the magnetic tape cartridges MC are transported to each quarter which made the delivery request by the carrying wagon C.

Next, a receiving site operation procedure in the computer room A2 will be explained by referring to FIG. 6, together with FIG. 2 as needed. FIG. 6 is a flowchart showing an operation flow of a terminal installed in a computer room.

First, the terminal 3 installed in the computer room A2 reads delivery address information stored in the tag 2 of the transported magnetic tape cartridge MC by using the reader-writer 31 (Step S11), and checks whether or not the delivery address is correct by the delivery address information checking unit 38a. In addition, the terminal 3 calculates arrival delay hours using the arrival delay hours calculating unit 38b by simultaneously reading a projected arrival time stored in the tag 2 (Step S12). Then, if there exists an erroneous delivery product, an erroneous delivery product list 5 (refer to FIG. 4) is created by the erroneous delivery product list creating unit 38c (Step S13). With the erroneous delivery product list 5, for example, a terminal administrator can know which magnetic tape cartridge MC is the erroneous delivery.

Through the above, the following advantages can be obtained in the embodiment.

When a magnetic tape cartridge MC is arrived at the computer room A2, the terminal 3 reads delivery address information of the magnetic tape cartridge MC, then, checks whether or not the computer room A2 is correct as a receiving site of the magnetic tape cartridge MC. That is, since delivery information such as delivery address information has been managed by a separate management unit in the conventional art, a delivery address could not be checked whether or not the delivery address is correct when one of the management unit and the terminal 3 is not online connection. However, in the embodiment, since the delivery information is directly written in the tag 2 which is mounted on a magnetic tape cartridge MC, the terminal 3 installed in the computer room A2 can check an erroneous delivery by itself without referring to, for example, the terminal 3 installed in the storage cabinet A1 and the separate management unit.

When a magnetic tape cartridge is arrived at the computer room A2, the terminal 3 reads projected arrival time information of the magnetic tape cartridge MC. Then, the terminal 3 calculates a difference between a projected arrival time and an actual arrival time of the magnetic tape cartridge MC, and checks whether or not a delay of the arrival time of the magnetic tape cartridge MC exists. That is, the terminal 3 installed in the computer room A2 can check an arrival delay by itself without referring to, for example, the terminal 3 installed in the storage cabinet A1 and the separate management unit. Meanwhile, if the arrival delay of the magnetic tape cartridge MC exists, a possibility of an information leakage by a fraud (bootstrapping) on a way of the transportation may be doubted.

That is, in the embodiment, checking of an erroneous delivery of a magnetic tape cartridge and checking of an arrival time delay can be implemented without building an online system. In addition, a system according to the embodiment can be prevented from a human error by eliminating a manual checking of the erroneous delivery.

The embodiment has been explained in the above. However, the present invention is not limited to the above embodiment. Various modifications of the embodiment may be possible.

For example, the following modifications may be possible. For example, the magnetic tape cartridge MC according to the embodiment is used in a system such as a library apparatus and a drive apparatus. However, rewriting of RFID tag information at outside of the system may be forbidden by placing a flag on the tag 2 for forbidding the rewriting. Thus, the RFID tag can be prevented from erroneous writing at outside of the system. In addition, information of the RFID tag can be prevented from easy rewriting by setting a password, or an authentication, or an encryption.

The memory 2c of the tag 2 may be divided into two portions, such as a fundamental information registration portion and a temporary information registration portion. For example, the fundamental information registration portion may be set as “rewriting forbidden” (temporarily or permanently “rewriting forbidden”), and the temporary information registration portion may be set as “rewriting forbidden” or “rewriting available”, as needed. In the setting other than the “rewriting forbidden” (password setting, authentication setting, encryption setting), a similar setting for preventing from rewriting may be available individually.

The delivery information to be written in the tag 2 may be written through encryption. With this, information of the RFID tag is prevented from falsification by a third party.

In the embodiment, the terminal 3 as a receiving site terminal reads a projected arrival time after reading delivery address information (Step S12 in FIG. 6). The present invention is not limited thereto. An opposite order for reading the projected arrival time and the delivery address information may be possible, and also a concurrent reading may be possible too.

In the embodiment, the delay hours calculating unit 38b calculates a difference between a current time and a projected arrival time. However, the present invention is not limited thereto. The delay hours calculating unit 38b may be configured to simply compare both clock times (times) for checking an existence of a delay.

Meanwhile, in the embodiment, the terminal 3 is configured to function as a delivering site terminal and a receiving site terminal. However, the present invention is not limited thereto, and the terminal at each site may be configured individually. That is, the terminal 3 at the delivering site may eliminate the delivery address information checking unit 38a, the delay hours calculating unit 38b, and the erroneous delivery product list creating unit 38c, and the terminal 3 at the receiving site may eliminate the delivery product list creating unit 37a and the ID information checking unit 37b. In addition, the reader-writer 31 is unnecessary to the terminal 3 at the receiving site, and a reader capable of reading information stored in the tag 2 may be sufficient.

What is claimed is:

1. A delivery product management system for managing a delivery product with an RFID tag, comprising:
a delivering site terminal provided with a delivering site reader-writer for reading and writing, or for reading information to be stored in the RFID tag; and
a receiving site terminal provided with a receiving site reader for reading the information stored in the RFID tag,
wherein the delivering site terminal reads identification information from the RFID tag of the delivery product by using the delivering site reader-writer, and writes delivery information containing at least delivery address information of the delivery product in the RFID tag after checking that the delivery product is correct based on the identification information, and
wherein the receiving site terminal reads the delivery address information from the RFID tag of the delivery product by using the receiving site reader, and checks whether or not a receiving site is appropriate for receiving the delivery product.

2. The delivery product management system according to claim 1, wherein rewriting of the information stored in the RFID tag is forbidden.

3. The delivery product management system according to claim 1, wherein a password is set in the information stored in the RFID tag.

4. The delivery product management system according to claim 1, wherein an authentication is set in the information stored in the RFID tag.

5. The delivery product management system according to claim 1, wherein an encryption is set in the information stored in the RFID tag.

6. The delivery product management system according to claim 1, wherein the delivery product is a magnetic tape cartridge.

7. The delivery product management system according to claim 1,
wherein the delivering site terminal writes the delivery information containing at least the delivery address information and information of a projected arrival time at the receiving site in the RFID tag of the delivery product by using the delivering site reader-writer, and
wherein the receiving site terminal reads the information of the projected arrival time from the RFID tag of the delivery product by using the receiving site reader, and checks whether or not a delay of an arrival time of the delivery product exists by comparing an actual arrival time of the delivery product and the projected arrival time.

8. The delivery product management system according to claim 7, wherein the projected arrival time is input by an operator by estimating the time for each case.

9. The delivery product management system according to claim 7, wherein the projected arrival time is automatically input based on current time and a necessary transportation time to a predetermined delivery address by inputting the delivery address information.

10. A delivery product management method for managing a delivery product with an RFID tag by a delivery product management system, which comprises:
a delivering site terminal provided with a delivering site reader-writer for reading and writing, or for reading information to be stored in the RFID tag; and
a receiving site terminal provided with a receiving site reader for reading the information stored in the RFID tag,
the delivery product management method comprising steps of:
reading identification information from the RFID tag of the delivery product by using the delivering site reader-writer;
checking whether or not the delivery product is a correct delivery product based on the identification information;
writing delivery information containing at least delivery address information of the delivery product in the RFID tag by using the delivering site reader-writer;
reading the delivery address information from the RFID tag of the delivery product by using the receiving site reader; and
checking whether or not a receiving site is correct for receiving the delivery product.

11. A delivery product management method according to claim 10, wherein rewriting of the information stored in the RFID tag is forbidden.

12. The delivery product management method according to claim 10, wherein a password is set in the information stored in the RFID tag.

13. The delivery product management method according to claim 10, wherein an authentication is set in the information stored in the RFID tag.

14. The delivery product management method according to claim 10, wherein an encryption is set in the information stored in the RFID tag.

15. The delivery product management method according to claim 10,
wherein the delivering site terminal writes the delivery information containing at least the delivery address information and information of a projected arrival time at the receiving site in the RFID tag of the delivery product by using the delivering site reader-writer, and
wherein the receiving site terminal reads the information of the projected arrival time from the RFID tag of the delivery product by using the receiving site reader, and checks whether or not a delay of an arrival time of the delivery product exists by comparing an actual arrival time of the delivery product with the projected arrival time.

16. The delivery product management method according to claim 15, wherein the projected arrival time is input by an operator by estimating the time for each case.

17. The delivery product management method according to claim 15, wherein the projected arrival time is automatically input based on current time and a necessary transportation time to a predetermined delivery address by inputting the delivery address information.
